(19) United States
(12) Patent Application Publication
(10) Pub. No.: US 2010/0194080 A1
(43) Pub. Date: Aug. 5, 2010

(54) METHODS FOR ILLUMINATION OF DRIVER AIRBAG EMBLEMS

(76) Inventors: Donald J. Paxton, Romeo, MI (US); Krzysztof W. Karwaczynski, Sterling Heights, MI (US)

Correspondence Address: Sally J. Brown;AUTOLIV ASP, INC., 3350 Airport Road, Ogden, UT, 84405, US

(21) Appl. No.: 12/363,460

(22) Filed: Jan. 30, 2009

(51) Int. Cl. B60R 21/20

(52) U.S. Cl. 280/728.3

(57) ABSTRACT

Methods for illuminating (backlighting) an emblem on a steering wheel cover include the use of a light guide, organic LEDs, or a fiber optic rope structure. The fiber optic rope may include many fiber optic filaments bunched together with a light source at one end. When this light source is activated, the filaments glow. For the organic LEDs, several layers of organic paint positioned on a substrate and the organic paint will emit light when a DC current is applied. For the light diffuser, LEDs are placed behind and opaque substrate that diffuses and disperse the light. All of these methods will provide sufficient illumination to backlight an emblem.

### BACKGROUND OF THE INVENTION

Airbag systems are commonly used on vehicles and especially in steering wheels. These airbags are designed to inflate during an accident to prevent the occupant from harmful impact with the steering wheel during a crash. Accordingly, the airbag system will generally be positioned in the steering wheel.

It is also known that most vehicle manufacturers want to have their logo or trademark on the steering wheel. These logos or trademarks are often colored images and are positioned on the steering wheel (such as on the cover of the steering wheel that is used to cover the airbag system). Some logos may also have a metallic chrome portion for improved appearance. Such positioning of the logo fosters brand recognition and also helps the vehicle occupant to remember that cars made by the vehicle manufacturer have airbags and are thus safer.

In order to further make the company's logo “stand out,” some parties have even begun to seek for ways to illuminate the logo/trademark. One example of this type of system is found in International Patent Publication No. WO 2007/084031, which document is expressly incorporated herein by this reference.

### BRIEF SUMMARY OF THE INVENTION

The present embodiments relate to different methods and ways to illuminate/backlight an emblem using non-traditional lighting methods that involve the use of direct light from a LED or light bulb. Such backlighting may be preferable as it can improve the aesthetic appeal of the emblem. Accordingly, the present embodiments involve an airbag apparatus. This apparatus comprises an airbag cover with an emblem that is positioned in front of an illumination source that operates to illuminate (backlight) the emblem. The illumination source may be an OLED, a light diffuser, or a fiber optic rope which are all illumination sources that do not involve a light guide or EL foil.

In one embodiment, the illumination source will be an organic light emitting diode (“OLED”) that may be powered via DC power (i.e., a DC power source). The use of DC power is advantageous as it is generated by the vehicle and does not require the additional step of conversion to AC power. OLEDs are presently known and used in video screens on computers, cell phones, etc. and are thus, inexpensive. More than one OLED may be used. The OLED is positioned on a substrate and would be positioned rearward of the emblem to provide the light to backlight the emblem. The OLED may comprise one or more layers of organic material (such as organic polymers) that emit the light. Those skilled in the art will appreciate how to construct, obtain, and/or illuminate the OLED. For example, the organic polymers may be part of a paint that is painted onto the substrate via one or more layers. The various layers may be positioned on the substrate. In some embodiments, the substrate may be a component of the OLED.

For example, in some embodiments, the OLED comprises a cathode, an anode, a conductive layer and an emissive layer, the conductive and emissive layers being positioned between the cathode and the anode. The cathode may be the top layer of the OLED and the anode may be the bottom layer of the OLED.

In another embodiment, the illumination source may comprise a rope structure of fiber optic fibers (which may also be referred to as fiber optic filaments). More than one rope structure may also be used. These fibers are grouped or wound together to form a rope-like structure. A light is positioned at one end of the fibers. When illuminated, light will exit or glow out of the side of the fibers, thereby providing the light that operates to backlight/illuminate the emblem. Thus, this embodiment may be referred to as a side glow fiber optic rope. This rope structure may be flexible and thus it may be bent or twisted into any desired shape or configuration, providing the vehicle manufacturer with the ability to tailor the illumination of the emblem how he or she desires.

Moreover, in some embodiments, light may also exit out of the distal end of the fibers when the light source is activated. Thus, if some of the fibers in the rope-structure are cut to have various, differing lengths. These fibers of different (shorter lengths) may be distributed evenly or unevenly throughout the rope structure. the light will exit out of these shorter ends, thereby creating a visually appealing design.

Additional embodiments may be constructed in which the illumination source comprises a light diffuser. More than one light diffuser may also be used. The light diffuser may be an opaque or translucent (i.e., non-transparent) surface behind which LEDs are mounted. The surface diffuses and distributes the light evenly, thereby preventing the formation of “dark spots” or “bright spots.” Rather, the illuminated emblem has a consistent, illuminated appearance. In some embodiments, the diffuser is made of a white, translucent plastic. Any other additional colors may be used, as desired.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of a front side of an airbag cover with an emblem that may be illuminated (backlit) according to the present embodiments;

FIG. 2 is a perspective view of an embodiment of the rear side of a light diffuser that may be used as an illumination source to illuminate an emblem;

FIG. 3 shows the front side of a light diffuser of FIG. 2 in its illuminated state;

FIG. 4 is a perspective, front view of an embodiment of a fiber optic rope structure that may be used as an illumination source to illuminate an emblem;

FIG. 5 is a perspective, front view of another embodiment of a fiber optic rope structure that may be used as an illumination source to illuminate an emblem;

FIG. 5A shows the appearance of an illuminated emblem when the illumination source of FIG. 5 is used;

FIG. 6 is a front, perspective view of an embodiment of a OLED that may be used as an illumination source to illuminate an emblem; and

FIG. 7 is an assembly view of the OLED of FIG. 6.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

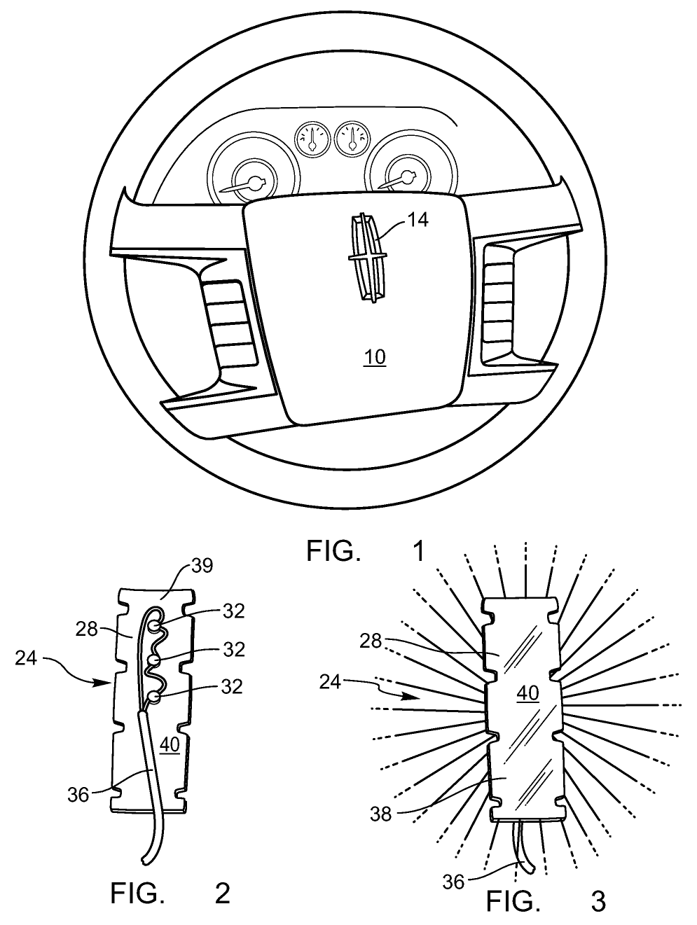

FIG. 1 is a perspective view of an airbag cover 10 that may be used a part of a steering wheel. The cover 10 covers the airbag (not shown). In the event of an accident or crash, the airbag will deploy through the cover 10. The cover may include an emblem 14 that represents the logo or trademark of the vehicle manufacturer. In some embodiments, the emblem 14 may be made of translucent chrome. Of course, other materials may also be used to make the emblem 14 as well. Those skilled in the art will appreciate a variety of different materials and different ways to attach/position the emblem 14 on the cover 10.

As noted above, some vehicle manufacturers may want to illuminate or backlight the emblem 14 in order to make the emblem 14 more visually appealing and make the emblem “stand out.” The embodiments herein describe various non-traditional methods for illuminating or backlighting the emblem 14 that do not involve EL foil or a light guide.

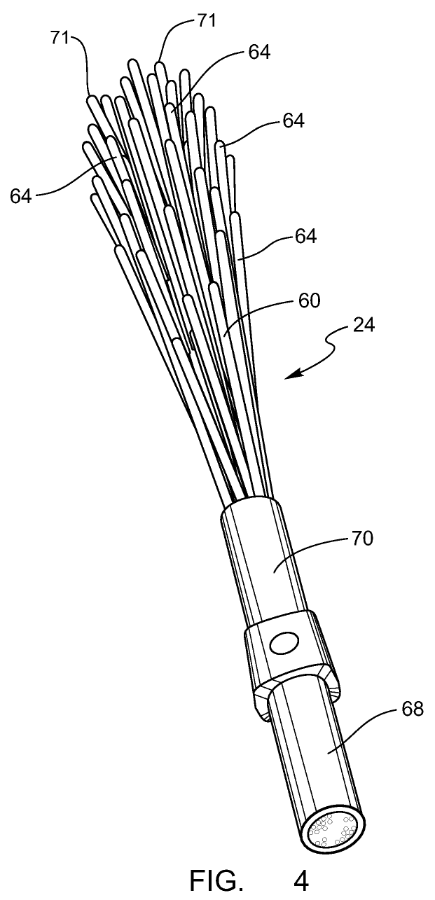

Referring now to FIG. 2, an embodiment of an illumination source 24 is illustrated that may be used to backlight the emblem 14 of FIG. 1. The illumination source 24 comprises a light diffuser 28 that includes one or more lights 32, such as LEDs 32. Of course, other types of light sources may also be used in place of or in addition to the LEDs 32. Wiring 36 may be used to provide the necessary power to the LEDs 32. The LEDs 32, when illuminated, will provide the appropriate light and power to illuminate the emblem 14 of FIG. 1.

The light diffuser 28 also includes a diffuser 40. The LEDs 32 are mounted to the rear surface 39 of the diffuser 40. The diffuser 40 may be an opaque surface, such as a white opaque surface made of plastic, paper, or other similar materials. Translucent materials, such as white translucent plastic, may also be used as the diffuser 40. The diffuser 40 is designed to diffuse and scatter the light. If no diffuser is used, “bright spots” may be formed on the illuminated emblem 14 corresponding to the position of the LEDs 32 and darker spots are formed where the LEDs are not located. However, by using this diffuser 40, the light is equally distributed/diffused so that there are no light spots or dark spots on the emblem. For example, FIG. 3 shows the illuminated light diffuser 28 (i.e., when the LEDs 32 are turned on) showing how the light is diffused equally with no light or dark spots visible through the diffuser 40. The front surface 38 of the diffuser 40 is illustrated and the LEDs 32 (not shown in FIG. 3) are positioned on the rear surface 39 (not shown in FIG. 3). It should also be noted that additional embodiments of the diffuser 40 may be constructed in which the diffuser 40 is “roughed”, such as via grit blasting, etc. Such “rough” spots on the diffuser 40 will further operate to diffuse/disperse the light and may improve the diffusing capability of the diffuser 40.

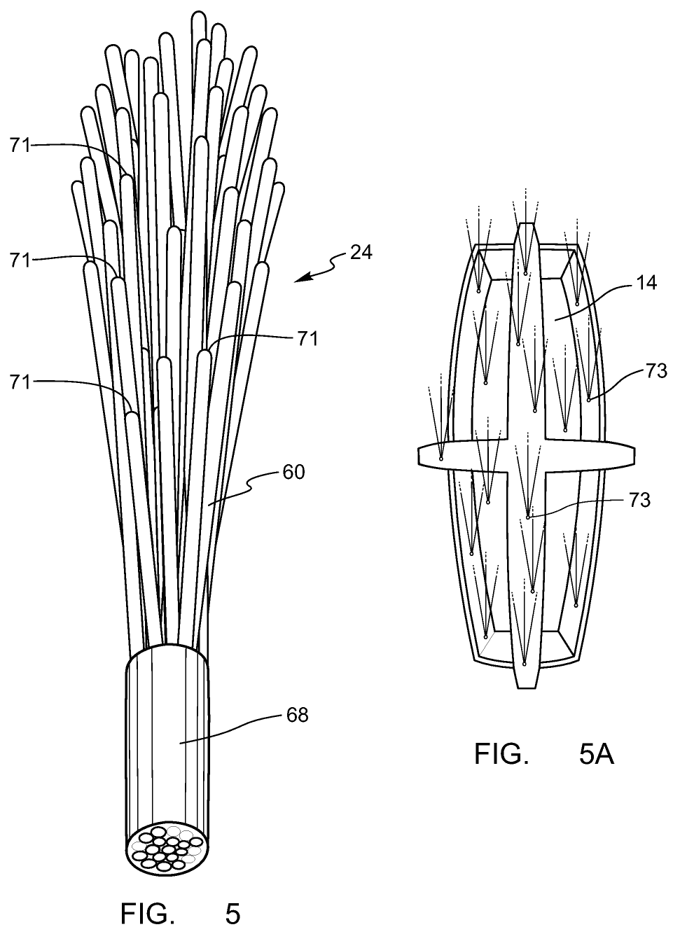

FIG. 4 shows a different example of an illumination source 24 that may be used to illuminate or backlight the emblem 14 of FIG. 1. In the embodiment of FIG. 4, the illumination source 24 comprises a rope structure 60 composed of a variety of different fiber optic fibers 64. These fiber optic fibers 64 are bunched together (or twisted or braided together) into the rope-like structure 60. A light source 68 is added to one end of the rope structure 60. The source 68 may be positioned or mounted within a housing 70. When the light source 60 is directed at the end of the rope structure 60, all of the fiber optic fibers 64 glow such that light is emitted from the side of the fibers 64, thereby providing the illumination sufficient to backlight the emblem 14. Such emissions of light may mean that the fibers 64 glow along the entire length of the rope structure 60. The light source 68 may be any color to produce the desired appearance and illumination effect upon the emblem.

Accordingly, the rope structure 60 can be spread over the back side of an emblem 14 of FIG. 1 which is to be illuminated, and when the light source is lit, the fibers 64 illuminate the emblem by light escaping from the side of the fibers 64. Some of the light may also exit out of the fibers 64 through the distal ends 71 (i.e., the end of the fibers 64 that is not housed within the housing 70). In fact, the light escaping the ends 71 may actually glow brighter than the light escaping from the sides of the fibers 64. One of the advantages of this rope structure 60 is that the rope structure 60 is inexpensive and is flexible and could be applied to any size or shape of the emblem 14, as necessary.

FIG. 5 shows another potential feature of the rope structure 60. Specifically, embodiments may be designed in which the fibers 64 can be cut to various lengths. Thus, with the fibers 64 will have their distal ends 71 positioned at different locations (and in some potential embodiments, even random locations). When illuminated, the ends 71 of the fibers 64 may also glow and may even glow brighter than the side of the fibers 64. By having various lengths of fibers 64 distributed or interspersed throughout the rope structure 60, the ends 71 of the shorter fibers 64 glow and appear as “sparkles” or “specks” of lights distributed throughout the emblem 14. This may be a desired effect and be visually appealing to some consumers. Accordingly, the vehicle manufacturer may choose to vary the length the fibers 64, as desired. Of course, if all of the fibers 64 are the same length, this sparkling effect may be reduced and/or eliminated as desired (by, for example, blocking the light that exits from the ends 71 of the fibers 64. FIG. 5A shows an example of an airbag cover 10 including an emblem 14 that is shown illuminated using the embodiment of FIG. 5. As can be seen in this Figure, there are “specks” or “sparkles” 73 of light distributed throughout the emblem 14 to create the desired “sparkled” look.

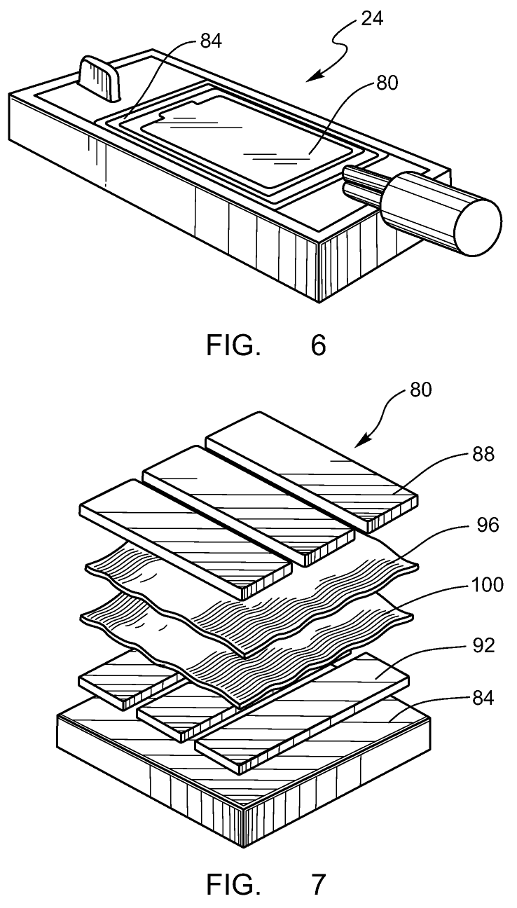

FIG. 6 is a perspective view of another embodiment of an illumination source 24 that may be used to illuminate or back light the emblem 14 of FIG. 1. In this embodiment, an organic light emitting diode (“OLED”) 80 is used as the illumination source 24. The OLED is printed on or otherwise added to a plastic substrate 84. OLEDs 80 are readily available and are used in video screens for computers, cell phones, PDAs, MP3 players, etc., and as such, the price of these devices continues to drop. Accordingly, one advantage of such features is the relative inexpensive nature of these devices and/or that they are readily available. Further, some OLEDs 80 presently run on DC current, which is normally supplied in a motor vehicle, rather than AC current.

FIG. 7 is an assembly view of one embodiment of the OLED 80 that has been added to the plastic substrate 84. The OLED 80 will comprise a cathode 88 and an anode 92. The cathode 88 and the anode 92 will generally be layers that are added to the substrate 84. The anode 92 will be the layer directly on the substrate 84 and the cathode 88 will be a separate and distinct layer. Between the anode 92 and the cathode 88 comprises an emissive layer 96 (which may be made of organic molecules or polymers) and a conductive layer 100 (which may also be made of organic molecules or polymers). Those skilled in the art would appreciate the materials that may be used for these layers and/or would appreciate where to purchase the OLED 80 and/or the materials used to make the OLED. In some embodiments the layers 88, 96 may be layers of paint that are added to the substrate 84. The substrate 84 may be any color as desired. Once properly positioned, the OLED may provide sufficient illumination to backlight the emblem. Also, a diffuser, similar to the diffuser 40 discussed above, could be used and could also be made of any desired color.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An airbag apparatus comprising:
an airbag cover including an emblem;
an illumination source designed to illuminate the emblem, the illumination source being selected from the group including an OLED, a light diffuser, or a fiber optic rope.

2. An airbag apparatus comprising:
an airbag cover including an emblem;
an OLED positioned on a substrate, the OLED designed to illuminate the emblem, the OLED and the substrate positioned rearward of the emblem.

3. An airbag apparatus as in claim 2 wherein the OLED comprises a cathode, an anode, a conductive layer and an emissive layer, the conductive and emissive layers being positioned between the cathode and the anode.

4. An airbag apparatus as in claim 3 wherein the cathode is the top layer of the OLED.

5. An airbag apparatus as in claim 2 wherein the substrate is a component of the OLED.

6. An airbag apparatus as in claim 2 wherein the OLED is powered via DC power.

7. An airbag apparatus comprising:
an airbag cover including an emblem;
a light diffuser comprising a non-transparent surface positioned in front of one or more LEDs, the diffusing surface designed to diffuse the light produced by the LEDs.

8. An airbag apparatus as in claim 7 wherein the diffuser is made of a white, translucent plastic.

9. An airbag apparatus comprising:
an airbag cover including an emblem;
a rope structure composed of fiber optic fibers and a light source positioned at one end of rope structure, wherein when the light source is activated, each of the fibers glows to illuminate the emblem.

10. An airbag apparatus as in claim 9 wherein the distal end of the fibers also glow when the light source is activated.

11. An airbag apparatus as in claim 10 wherein fibers of different lengths are distributed through the rope structure.
